(19) United States
(12) Patent Application Publication
(10) Pub. No.: US 2007/0245323 A1
(43) Pub. Date: Oct. 18, 2007

(54) Sharing compiled versions of files

(75) Inventor: Anders I. Bertelrud, Burlingame, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Computer, Inc.

(21) Appl. No.: 11/404,420

(22) Filed: Apr. 13, 2006

(51) Int. Cl. G06F 9/45

(52) U.S. Cl. 717/140

(57) ABSTRACT

Sharing compiled versions of files among machines is disclosed. In some embodiments, upon determining at a machine that a file needs to be compiled, a previously compiled version of the file is requested and received from one or more other machines. In such a case, the processing associated with generating a compiled version of the file at the machine can be eliminated. Similar techniques can be employed to share and/or reuse a previously generated output of any repeatable computing task whose inputs can be characterized.

### BACKGROUND OF THE INVENTION

In a software development environment, the members of a team of developers frequently only modify a small percentage of the total files comprising an associated code base before building the code base to test the modifications. Building a code base can take a considerable amount of time, especially when a code base includes a large number of files that need to be compiled. Various techniques have been employed in the past to accelerate the build process.

One technique for accelerating the build process involves distributing a build over peer machines in a software development environment so that multiple machines are compiling files in parallel. In such cases, a machine building a code base typically requests one or more peer machines to compile files and send the compiled versions of the files back to the machine. Another technique for accelerating the build process involves locally caching compiled versions of files at a single machine when they are generated at that machine during a build so that when a subsequent build is performed at that machine at least some of the locally cached compiled versions of the files may be reused.

The existing approaches for accelerating build processes, however, fail to fully leverage the resources available at peer machines in an associated development environment. Thus, there is a need for an improved way to accelerate build processes.

### BRIEF DESCRIPTION OF THE DRAWINGS

Various embodiments of the invention are disclosed in the following detailed description and the accompanying drawings.

FIG. 1A illustrates an embodiment of a network environment in which a group of hosts or computing machines are interconnected by a network.

FIG. 1B illustrates an embodiment of a repeatable computing task.

FIG. 1C illustrates an embodiment of a process for performing a repeatable computing task.

FIG. 2 illustrates an embodiment of a manner of building a code base.

FIG. 3 illustrates an embodiment of a process for building software.

FIG. 4 illustrates an embodiment of a manner for building a code base.

FIG. 5 illustrates an embodiment of a compiler.

FIG. 6 illustrates an embodiment of a process for building a code base.

FIG. 7 illustrates an embodiment of a process for generating a list of files needed to build a code base.

FIG. 8 illustrates an embodiment of a process for making available existing object code files.

FIG. 9 illustrates an embodiment of a process for providing one or more existing object code files.

FIG. 10 illustrates an embodiment of a process for responding to an offer for an object code file.

FIG. 11 illustrates an embodiment of a process for providing one or more existing object code files.

FIG. 12 illustrates an embodiment of a process for receiving object code files.

FIG. 13 illustrates an embodiment of a process for generating object code files.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Sharing compiled versions of files among machines is disclosed. In some embodiments, upon determining at a machine that a file needs to be compiled, a previously compiled version of the file is requested and received from one or more other machines. In such a case, the processing associated with generating a compiled version of the file at the machine can be eliminated. The techniques described herein are not limited to compiling but can be employed to share and/or reuse previously generated output(s) of any repeatable computing task whose input(s) can be characterized.

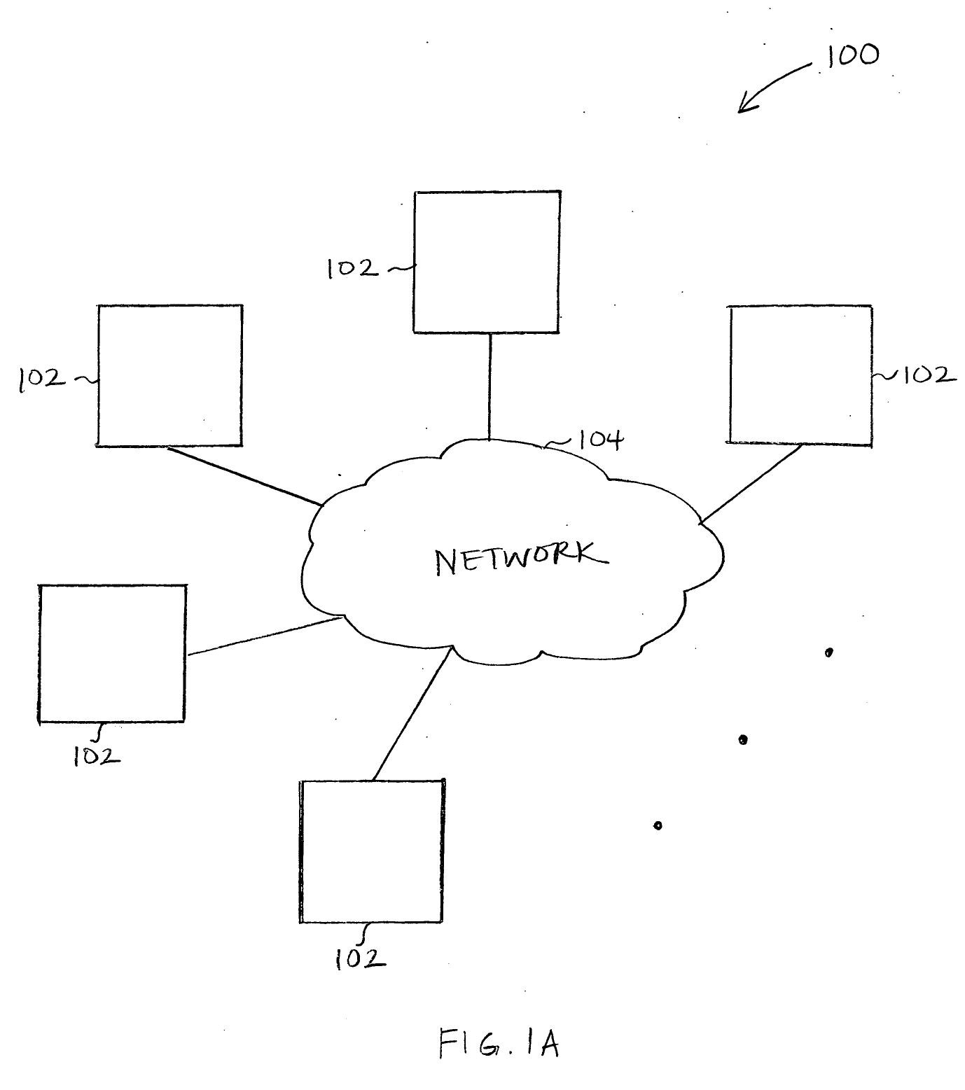

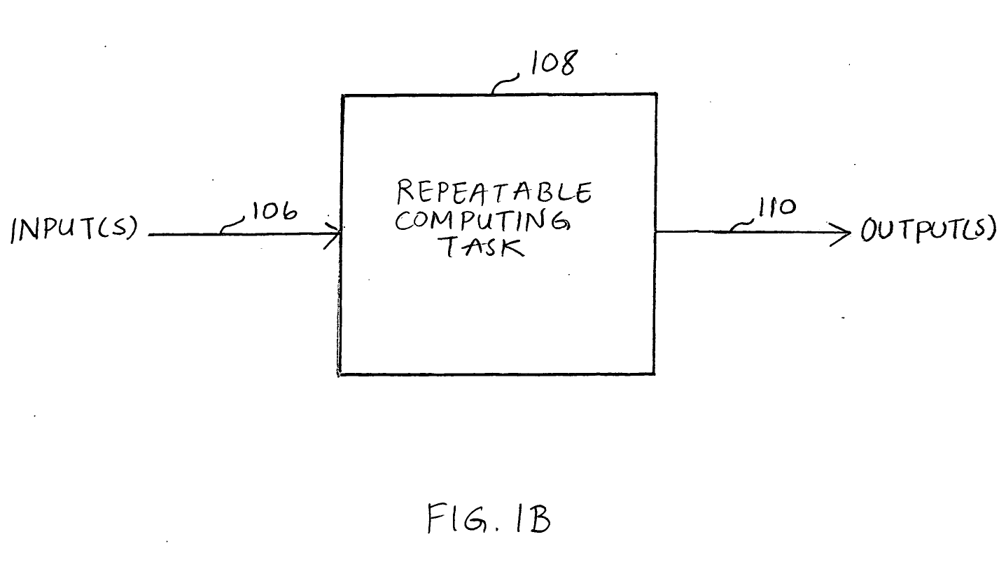

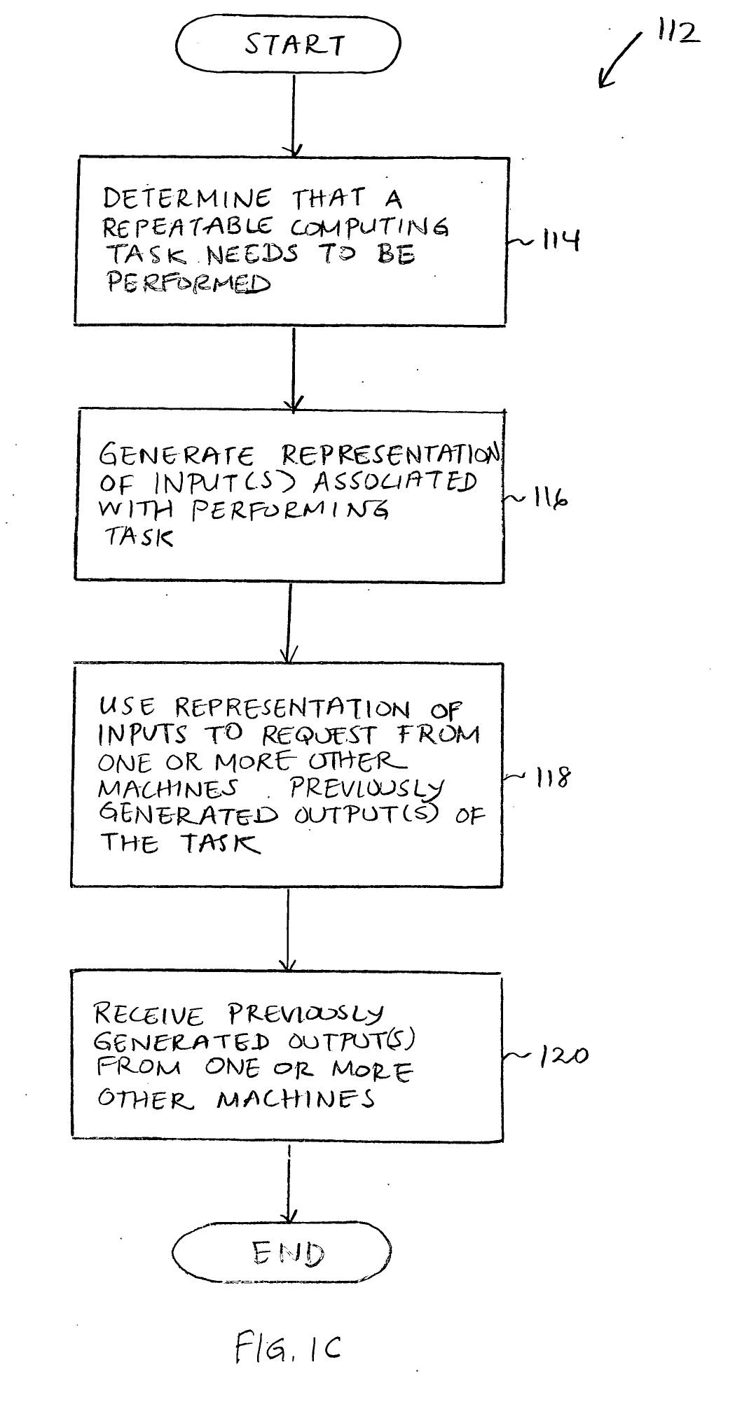

FIG. 1A illustrates an embodiment of a network environment in which a group of hosts or computing machines are interconnected by a network. As depicted, network environment 100 includes a plurality of machines 102 interconnected by a network 104. Network 104 may correspond to any private or public network, such as a LAN, WAN, the Internet, etc. In some embodiments, a group of local machines 102 are interconnected by a private, internal network 104, and relatively fast connection speeds exist between machines 102, such as, for example, when machines 102 are interconnected via 100 MB or 1 GB Ethernet. In some embodiments, one or more of the machines 102 may be remotely connected to an internal network 104, such as, for example, via a virtual private network.

FIG. 1B illustrates an embodiment of a repeatable computing task. As depicted, one or more inputs 106 into a repeatable computing task 108 produce one or more outputs 110. Since the processing associated with computing task 108 is repeatable, the same inputs 106 always produce the same outputs 110. If all of a set of one or more inputs 106 that affect or may affect the processing associated with computing task 108 can be characterized, a mapping can be established between the set of one or more inputs 106 and the set of one or more outputs 110 generated by performing the computing task 108 using the set of inputs 106. In some embodiments, such a mapping may be employed to reuse a set of previously generated and stored outputs in lieu of repeatedly performing the same computing task with the same set of inputs.

FIG. 1C illustrates an embodiment of a process for performing a repeatable computing task such as 108 of FIG. 1B. Process 112 begins at 114 at which it is determined that a repeatable computing task needs to be performed. In some embodiments, the determination of 114 is made by a machine in a network environment that includes one or more other machines. At 116, a representation of the set of one or more input conditions associated with performing the task is generated. In some embodiments, the representation of 116 includes a hash of the set of inputs. At 118, the representation of the set of inputs generated at 116 is used to request from one or more other machines in an associated network environment a previously generated set of one or more outputs of the task for that set of input conditions. At 120, a previously generated set of one or more outputs is received from one or more of the other machines. Process 112 subsequently ends. In some embodiments, process 112 is employed by a machine from a set of machines 102 in network environment 100 of FIG. 1A.

In some embodiments, network environment 100 of FIG. 1A corresponds to a software development environment in which a group of software development machines 102 associated with a team of developers are interconnected by a network 104. The size of a software development team and thus the number of machines 102 being used is often proportional to the complexity of the software being developed by the team. The software development process is often limited by build speeds, especially when a code base is complex and includes a large number of files. For example, a code base that includes thousands of files may take several hours to build. Most individual developers on a software development team work on the same version of a code base (i.e. the same set of source code files) and tend to modify only a small percentage of the total source code files that comprise the code base at any given time. Nevertheless, each developer traditionally has had to compile the entire set of source code files that comprises the code base when building a debug build of the code base so that the modifications made by the developer can be tested.

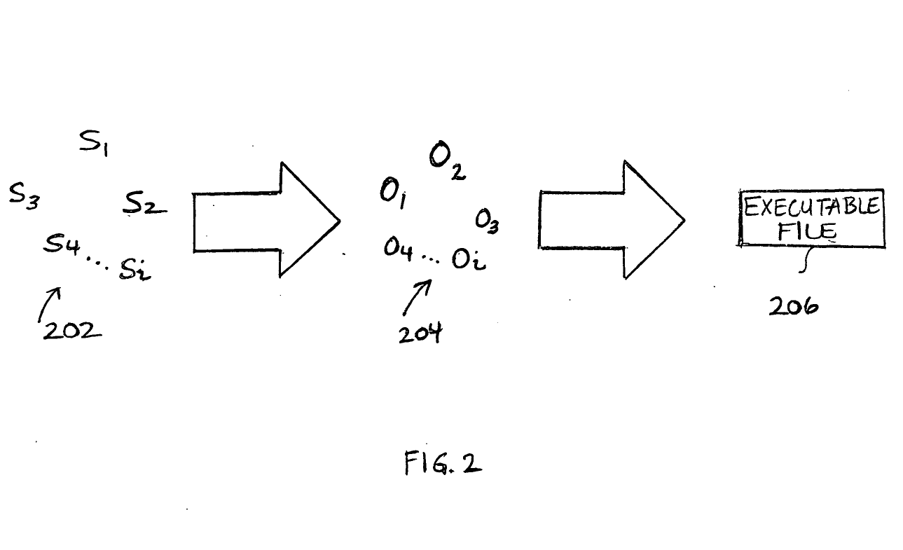

FIG. 2 illustrates an embodiment of a manner of building a code base. The code base 202 of a software product or project typically includes a large number of source code files: S₁, S₂, S₃, S₄, . . . , Sᵢ. In order to build the software, each source code file in the code base 202 is compiled into an object code file. In the given example, source code file S₁ is compiled into object code file O₁, source code file S₂ is compiled into object code file O₂, and so on. The resulting object code files O₁ through Oᵢ 204 are subsequently linked together to generate a machine executable file 206 associated with the software.

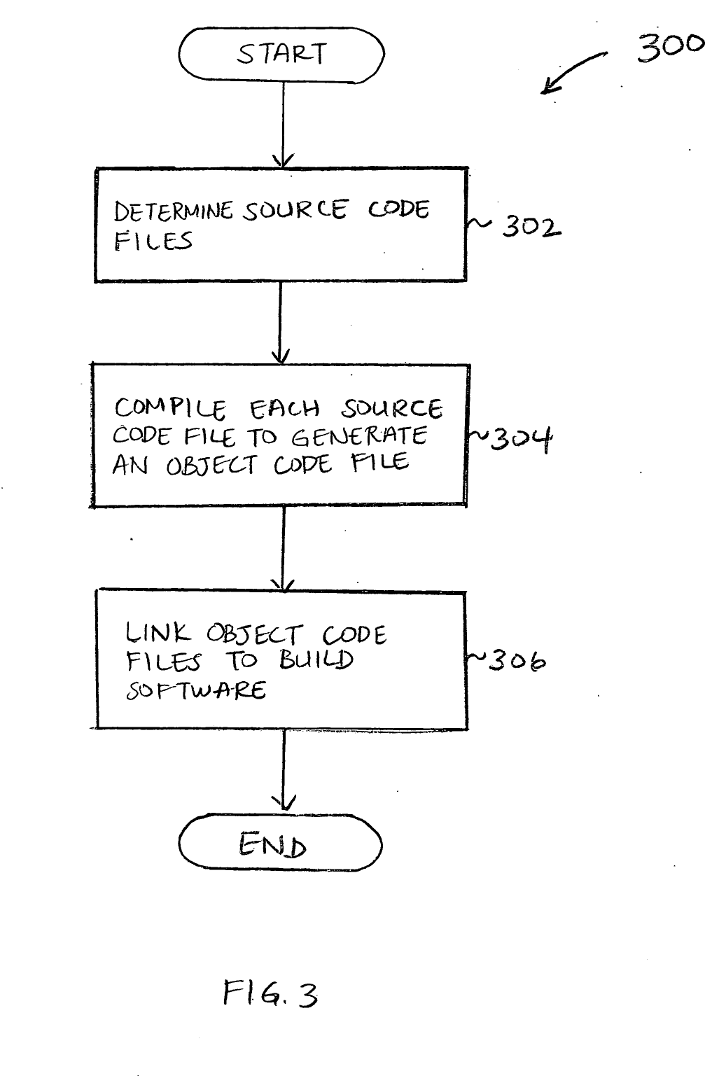

FIG. 3 illustrates an embodiment of a process for building software. Process 300 may be employed to build any type of software, such as programming software, system software, application software, etc. Process 300 begins at 302 at which the source code files that comprise a code base are determined. At 304, each source code file in the code base is compiled to generate a corresponding object code file. At 306, the object code files generated at 304 are linked together to build the software. That is, the object code files are linked at 306 to generate a corresponding machine executable file.

In a software development environment, most of the developers of the software development team use the same version of the code base, the same compiler version, the same software development kit (SDK), i.e. header files and libraries, etc. During the software development process, each developer on the software development team may need to build the code base of the software product being developed one or more times. A developer typically modifies only a very small percentage of the total source code files comprising an associated code base before building a debug build of the software in order to test the modifications. Thus, in a typical software development environment, developers on the software development team are often compiling source code files most of which are the same as those being compiled by others and/or those compiled previously by themselves, using the same compiler input conditions, e.g., the same compiler version, same SDK version, etc. Compiling the associated source code files when building a code base can take a considerable amount of time, especially when the code base is complex and includes a large number of source code files. In such cases, it is desirable to improve build speeds so that build times can be reduced or minimized.

In some embodiments, build speeds are accelerated through the reuse and/or sharing of previously compiled object code files in a software development environment. The processing by a compiler is repeatable, i.e. the same set of inputs into a compiler produce the same set of outputs. Thus, by characterizing the set of input conditions that produce a particular object code file, it is possible to reuse that same object code file whenever a compilation of the same set of input conditions (e.g., input source code file, compiler version, compiler configuration/option settings, etc.) is needed. Build speeds can be greatly improved if object code files that have been previously generated by compiling their associated source code files are stored and reused instead of recompiling the same source code files under identical compiler input conditions each time the code base is built. Moreover, further improvements in build speeds can be achieved if such object code files are shared amongst a software development team so that a machine does not have to repeat processing steps that have already been performed at one or more peer machines in the software development environment. Most of the machines in a software development environment typically exist on the same side of an associated router, and often the network bandwidth that exists between these machines is not heavily used. In such cases, transporting existing object code files between machines is often much faster than compiling locally at a machine building the code base all of the source code files that comprise the code base. Sharing object code files even when relatively slower connections exist between a machine building a code base and its peers, such as when the machine is remotely communicating with its peers, is in some embodiments faster than locally generating files that are already available at one or more peers and can be made available to the machine building the code base.

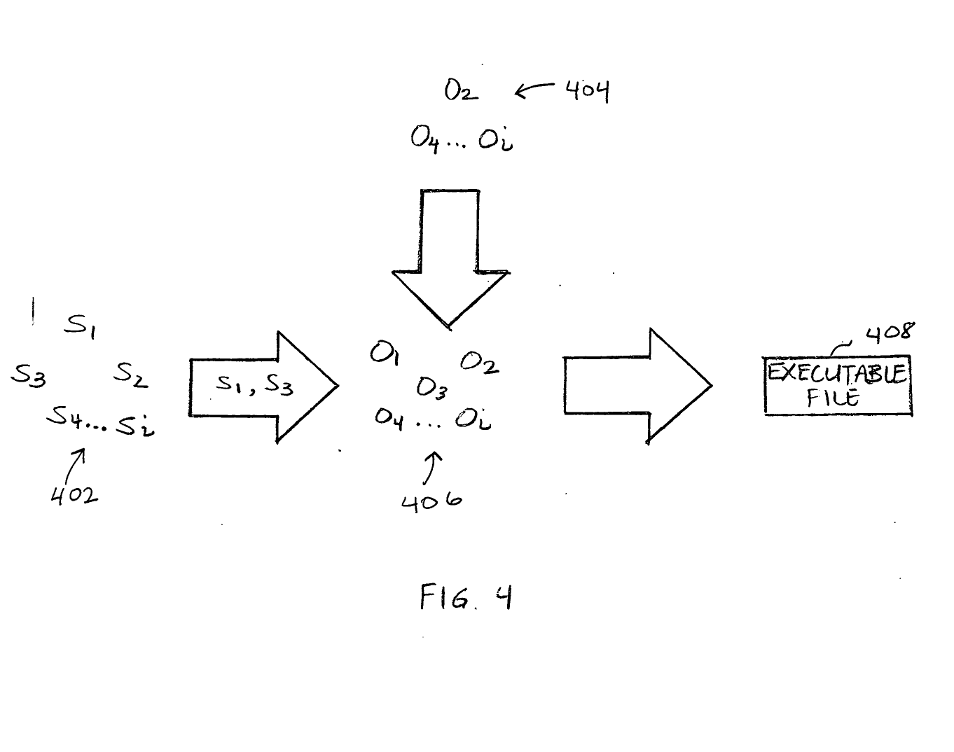

FIG. 4 illustrates an embodiment of a manner for building a code base. As depicted, the code base 402 of a software product or project comprises a set of source code files S₁, S₂, S₃, S₄, . . . , Sᵢ. At any given time, a developer usually modifies only a small percentage of the total number of source code files comprising the code base before building the software to test the modifications. Thus, when a build is initiated at a machine, most of the source code files remain unmodified. Consider in the given example that source code files S₁ and S₃ have been modified but the rest of the source code files S₂, S₄, . . . , Sᵢ have not been changed. Since it is likely that one or more of the source code files, especially the ones that have not been modified, have been previously compiled with the same compiler input conditions at the same machine and/or at a peer machine in an associated software development environment, the compilation of such a source code file can be avoided if its corresponding object code file can be obtained either from the machine building the code base 402 or from a peer machine in the software development environment.

In some embodiments, whenever a machine compiles a source code file, the resulting object code file and any other associated outputs resulting from the compilation process are locally stored at the machine in memory or storage so that they can be reused in the future at that machine when building a code base that includes the same source code file with the same compiler input conditions or so that they can be transmitted to another machine in the software development environment that is building a code base that includes the same source code file with the same compiler input conditions. Thus, in some embodiments, the object code files stored at peer machines participating in the sharing of object code files in a software development environment comprise a distributed cache of object code files, any of which may be made available to a requesting peer when the peer that has a desired file is not busy with its own processing and is able to supply the desired file to the requesting peer.

Although the sharing of object code files amongst peer machines may be sometimes described herein, any other appropriate configuration may be employed to facilitate the sharing of previously generated object code files so that their associated source code files do not have to be repeatedly compiled in a software development environment. For example, in some embodiments, object code files and any other associated outputs generated by compiling source code files at one or more machines in a software development environment are stored at a dedicated server or repository. Such a commonly accessible location may be used by the machines in the software development environment to store and retrieve object code files. In some embodiments, object code files stored at peer machines and a dedicated server or repository comprise a distributed cache of object code files that are available for sharing.

Returning to FIG. 4, in the given example, only the modified source code files S₁ and S₃ are locally compiled by the machine building code base 402. The rest of the source code files S₂, S₄, . . . , Sᵢ that are not modified are not locally compiled into corresponding object code files. Rather, previously generated object code files 404 corresponding to these source code files are obtained from memory or storage from the machine building the code base 402 and/or from one or more peer machines in an associated software development environment. In some embodiments, the machine building the code base 402 may not be able to obtain an already existing object code file for a source code file that has not been modified at the machine, for example, because such an object code file does not exist or no longer exists at the machine or any of its peers, because other input conditions to a compiler that affect the object code file generated by the compiler have been changed even though the source code file has not been modified at the machine, because a peer machine that has the desired object code file is busy and is not able to provide the desired object code file in a timely fashion, because network traffic on the network over which the machine and the peer machine are communicating prevents delivery of the desired object code file from the peer machine in a timely fashion, etc. Thus, if the machine building the code base 402 is unsuccessful (or not immediately successful) in its attempts to obtain a desired object code file, it may compile the associated source code file itself in order to proceed with the building process. Once object code files 406 for each of the source code files in the code base 402 are obtained, the object code files 406 are linked together to generate an executable file 408.

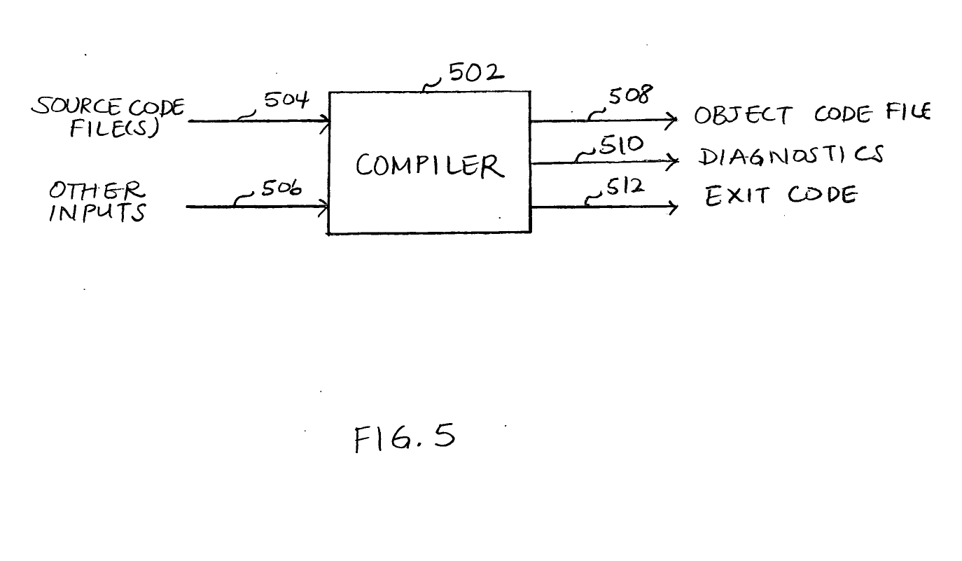

FIG. 5 illustrates an embodiment of a compiler. The high-level functionality of a compiler is typically defined as translating an input source code file into an output object code file. However, the output object code file generated by a compiler may also depend on other compiler input conditions. Moreover, for a given set of one or more inputs, a compiler may also output other information, such as diagnostic data (e.g., warnings, errors, etc.) associated with the compilation process, an exit code (e.g., “0” for success, “1” for failure), etc. In the example of FIG. 5, inputs to compiler 502 include one or more source code files 504 and any other compiler input conditions 506 that may affect the compilation process and resulting outputs.

Compiler inputs that may affect the compilation process and resulting outputs of a compiler include, but are not limited to, one or more of the following: the contents of the input source code file(s) being compiled, the contents of any headers or include files included either directly or recursively in the source code file(s) being compiled, the version of the SDK and/or compiler, the version or contents of the compiler binary, any compiler flags that affect the compiler output, any environmental variables that affect the compiler output, other options such as the selected optimization level, etc. Other compiler inputs that may affect the compiler outputs may be handled in a manner that still permits the sharing of compiler outputs across machines in a software development environment. For example, the path of a source code file may be parameterized so that instead of the full path only an appropriate suffix of the path, which is often the same for most machines desiring to compile the source code file in a software development environment, is a part of the compiler input conditions 506. In such cases, in some embodiments, the prefix of the path, which corresponds to local locations on machines and that is likely to vary across the different machines in the software development environment, may be prepended to one or more compiler outputs individually at each machine if desired so that the sharing of compiler outputs is still possible across the machines.

In FIG. 5, other inputs 506 includes any input condition that may affect the outputs of compiler 502. As depicted, in addition to an object code file 508, compiler 502 outputs other data, such as diagnostic data 510 and an exit code 512. The compilation process performed by a compiler such as compiler 502 is a repeatable process given the same set of input conditions. That is, compilation of the same set of inputs (e.g., 504 and 506) by the same compiler (e.g., 502) yields the same set of outputs (e.g., 508, 510, 512) each time such a compilation is performed and irrespective of the machine at which it is performed.

The reuse and sharing of previously generated and stored object code files is possible through the characterization of all the input conditions of a compiler that affect its outputs. If it can be determined that a source code file that needs to be compiled has been previously compiled by the same compiler using all the same input conditions, the actual compilation process by the compiler can be eliminated and the previously generated object code file as well as its other associated compiler output data can be used instead of repeating the compilation process. In some embodiments, each stored object code file is associated with a corresponding identifier that uniquely identifies the set of compiler inputs that resulted in producing that particular object code file and its other associated compiler outputs.

In some embodiments, each unique set of inputs that may affect the compilation process and resulting outputs of a compiler are assigned a unique identifier. In some embodiments, each set of compiler inputs that may affect the compilation process and resulting outputs are hashed, which results in a unique (or mathematically highly improbable to not be unique) identifier for each unique set of compiler inputs. Such a unique identifier or input condition signature is associated with its corresponding set of compiler outputs. In some embodiments, whenever a source code file is compiled at a machine, the hash of the contents of the source code file and any other arbitrary inputs that may affect the outputs of the compiler is mapped to and/or stored with the resulting set of compiler outputs. For example, with respect to FIG. 5, the inputs 504 and 506 to compiler 502 are hashed, and the resulting hash value is mapped to and/or stored with the resulting set of compiler outputs 508, 510, and 512. In some embodiments, a hash value associated with a set of compiler inputs is added to a list that maps the hash value to its corresponding compiler outputs, and such a list may be used for lookup when attempting to retrieve a desired set of compiler outputs. The hash function may comprise MD5 (Message-Digest Algorithm 5), SHA-1 (Secure Hash Algorithm-1), or any other appropriate hash function that generates a hash value of manageable size.

In some embodiments, each peer machine participating in sharing object code files in a software development environment includes one or more mappings of input condition signatures to object code files. Such mappings may be used to identify and provide desired object code files to requesting machines in the software development environment. Thus, in some embodiments, the peer machines participating in the sharing of object code files in a software development environment form a distributed cache of compiled source code files that may be transported between machines and reused. An object code file and any of its other associated compiler outputs that are cached at a machine in the software development environment may be purged, for example, after the expiration of a prescribed period of time, after the object code file has been deemed to be obsolete due to, for example, modifications in an associated source code file or compiler binary, etc.

Although the compilation of a source code file into an object code file may be sometimes described herein for simplicity, it should be noted as described above that a compilation process may involve translating a set of one or more inputs (e.g., 504 and 506 of FIG. 5) into a set of one or more outputs (e.g., 508, 510, 512 of FIG. 5). Thus, as sometimes described herein, storing an object code file may include storing its other associated compiler outputs, if any, and supplying a desired object code file to a requesting machine by a peer machine may include supplying its other associated compiler outputs, if any, as well.

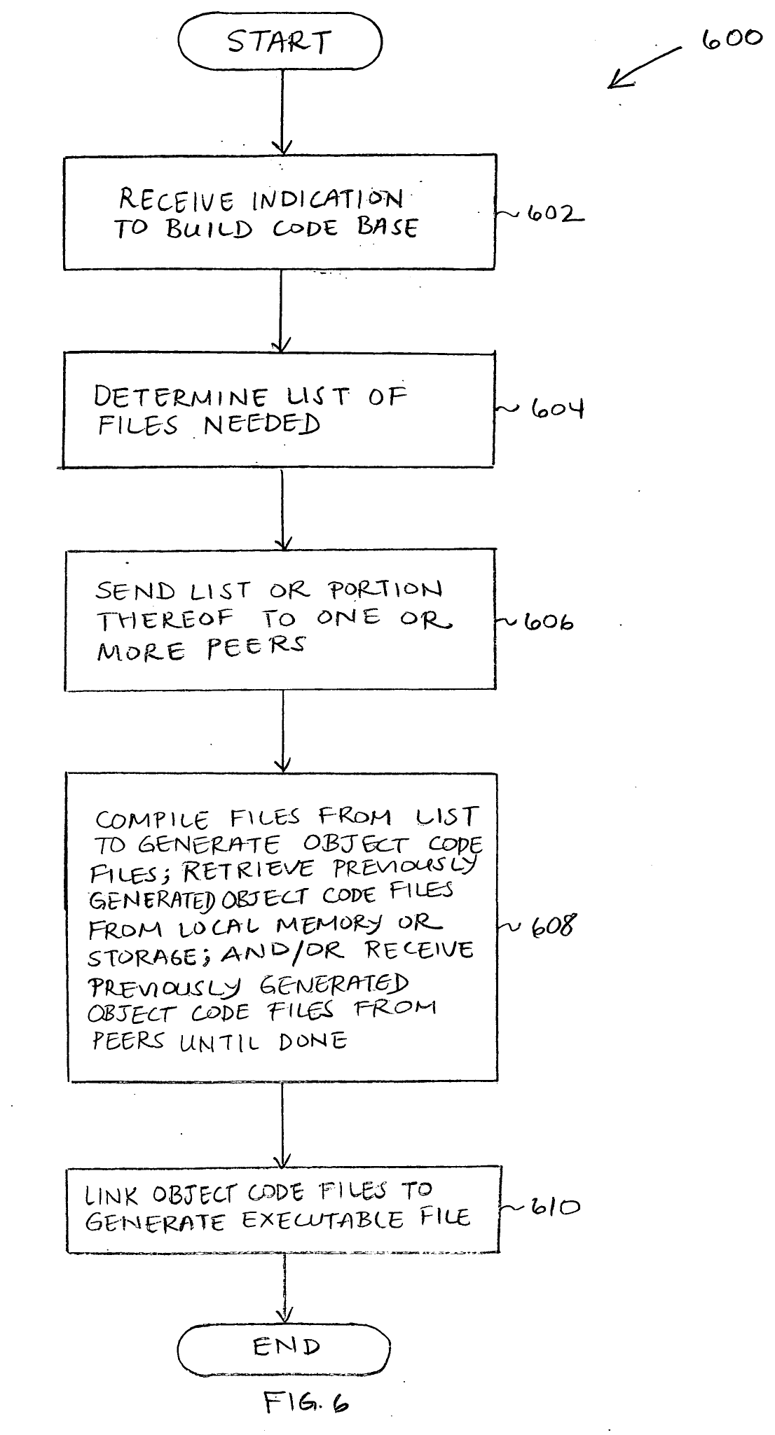

FIG. 6 illustrates an embodiment of a process for building a code base. In some embodiments, process 600 is employed when a developer initiates a debug or other build on a machine. Process 600 begins at 602 at which an indication to build a code base is received. Such an indication may be received, for example, by an integrated development environment (IDE) associated with a machine. At 604, a list of files that are needed to build the code base is determined. In some embodiments, the list of files includes an entry for each source code file in the code base. In some embodiments, 604 includes computing signatures (e.g., hash values) of each set of unique compiler input conditions that need to be compiled in order to build the associated code base, and the list is comprised of such input condition signatures. In some embodiments, the list determined at 604 is categorized or parsed, for example, to identify entries of the list associated with source code files that have been currently modified at the machine, to identify entries of the list associated with source code files that have been recently compiled at the machine or at one or more peer machines, to identify entries of the list associated with source code files that have remained unchanged for prescribed periods of time, etc.

At 606, the list determined at 604 is sent to one or more peer machines in a software development environment. In some embodiments, only a portion of the list, such as the portion of the list that corresponds to source code files that have not been modified at the requesting machine and/or whose corresponding object code files do not already exist at the requesting machine in a local cache is sent to one or more peers at 606. The list or portion thereof may be broadcast, multicast, or individually transmitted to one or more peer machines at 606. In some embodiments, at 606 the list or a portion thereof is sent to a dedicated server or repository that stores compilation outputs previously generated by machines in an associated software development environment and that supplies such compilation outputs to the machines when requested.

At 608, source code files associated with one or more entries of the list are locally compiled at the machine building the code base to generate corresponding object code files; object code files generated from previously compiling compiler input conditions identical to those associated with one or more entries of the list are retrieved from the machine's own cache, memory, or long term storage; and/or object code files generated from previously compiling compiler input conditions identical to those associated with one or more entries of the list are received from peer machines until object code files for all of the source code files associated with the list determined at 604 have been obtained. Since a compilation process often results in the generation of more than just the object code file, other associated compiler outputs such as diagnostic data and an exit code may be generated, retrieved, and/or received with a corresponding object code file at 608.

In some embodiments, the machine building the code base begins by compiling source code files that have most recently been modified at the machine since the object code files corresponding to such source code files are least likely to be available from any of the peer machines in an associated software development environment. In some embodiments, the machine building the code base only compiles the source code files currently modified at the machine (i.e., modified locally since a last build at the machine) and receives object code files for source code files that have not been modified from one or more peer machines or from its own memory or storage. In some embodiments, the machine building the code base compiles a source code file that has not been modified at the machine because the desired object code file does not already exist or no longer exists at the machine or at any of its peers, because a peer machine that has the desired object code file is busy and is not able to fulfill the request, because excessive network traffic prevents a peer machine from supplying the desired object code file to the requesting machine in a timely fashion, etc. At 610, the object code files corresponding to the source code files that comprise the code base are linked to generate an executable file, completing the build of the code base. Process 600 subsequently ends.

In some embodiments, a process such as process 600 for building a code base balances the load on the machines participating in the sharing of object code files in a software development environment. For example, in some embodiments, a requesting machine merely posts or presents (e.g., broadcasts, multicasts, etc.) a list of needed object code files to its peers rather than issuing specific requests to one or more peers, and each peer responds to the requesting machine based upon it own current availability and work load. If a peer is busy with its own processing, it need not reply at all to the requesting machine. A requesting machine can obtain as many pre-existing object code files from its peers as possible and can generate the remaining by itself. In some embodiments, when multiple peer machines are available to supply the same object code file, each machine may send one or more portions of the object code file so that the load on each machine can be balanced or reduced. In some embodiments, parallel processing may be employed to distribute the needed compilations across multiple machines in a software development environment. That is, in order to accelerate the build process, the machine building the code base may request one or more available peers to compile one or more source code files that need to be compiled.

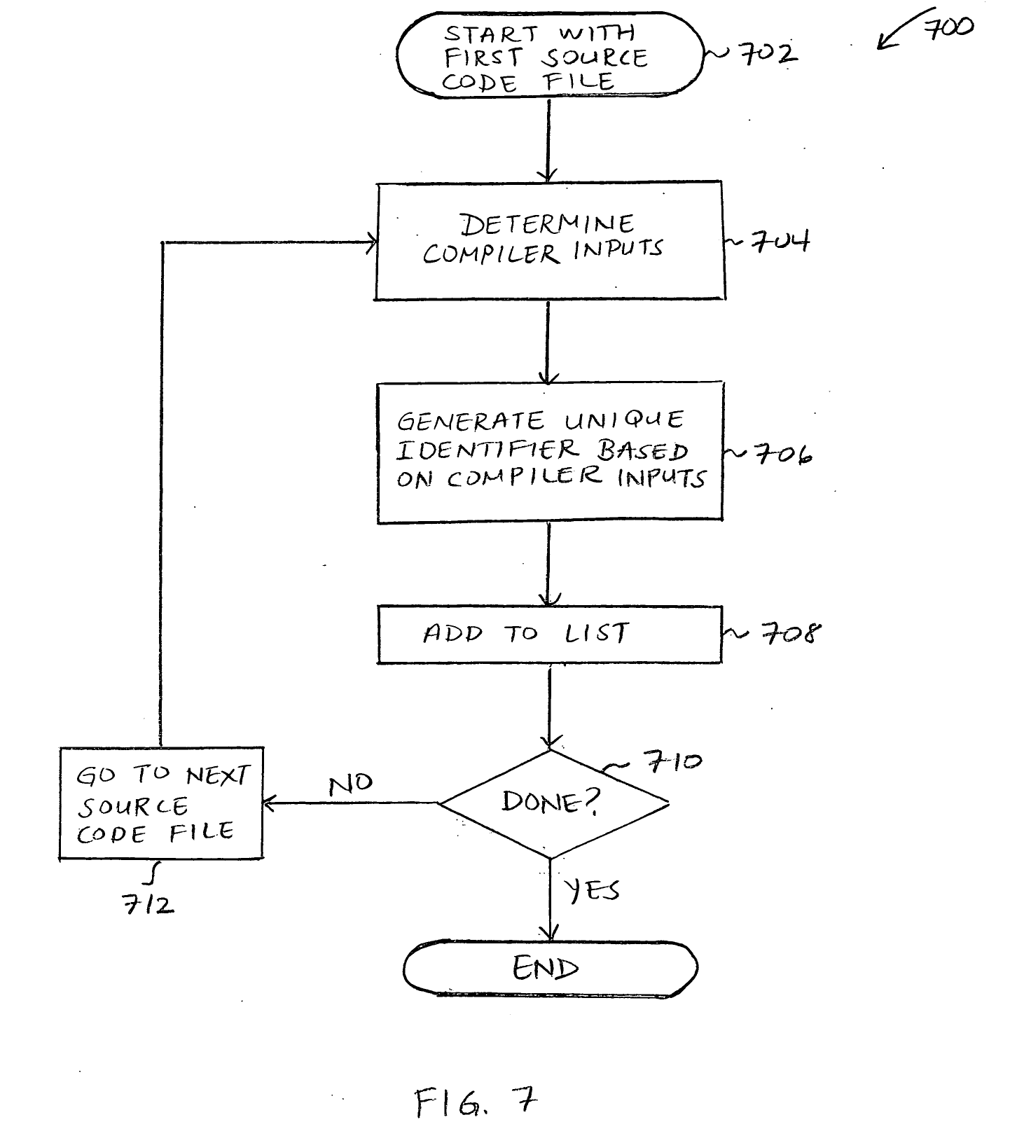

FIG. 7 illustrates an embodiment of a process for generating a list of files needed to build a code base. In some embodiments, process 700 is employed to determine the list of files at 604 of process 600 of FIG. 6. In some embodiments, the list generated using process 700 includes an entry for each source code file in the code base that needs to be compiled to build the code base. Process 700 starts at 702 with a first source code file from the code base that needs to be added to the list. At 704, the compiler inputs associated with compiling the source code file of 702 that may affect the compilation process and the resulting compiler outputs are determined. Compiler inputs that may affect the compilation process and resulting outputs include, but are not limited to, one or more of the following: the contents of the input source code file being compiled, the contents of any headers or include files included directly or recursively in the source code file being compiled, the version or contents of the SDK, the version or contents of the compiler binary, any compiler flags that affect the compiler output, any environmental variables that affect the compiler output, other compiler options such as the selected optimization level, the suffix of the path of the source code file being compiled, etc.

At 706, a unique identifier or signature is generated based on the compiler inputs determined at 704. In some embodiments, the unique identifier is generated by hashing the compiler inputs that affect the compilation process and resulting compiler outputs determined at 704 with an appropriate hashing function or algorithm. For example, the unique identifier may comprise the 128-bit hash value resulting from an MD5 digest of the compiler inputs determined at 704. At 708, the unique identifier generated at 706 is added to the list. At 710, it is determined whether an entry for each source code file that needs to be compiled has been added to the list. If it is determined at 710 that an entry for each source code file that needs to be compiled has not been added to the list, process 700 proceeds with the next source code file at 712 and returns back to step 704 at which the compiler inputs associated with compiling the source code file of 712 that affect the compilation process and the resulting compiler outputs are determined. If it is determined at 710 that an entry for each source code file that needs to be compiled has been added to the list and the list is complete, process 700 ends.

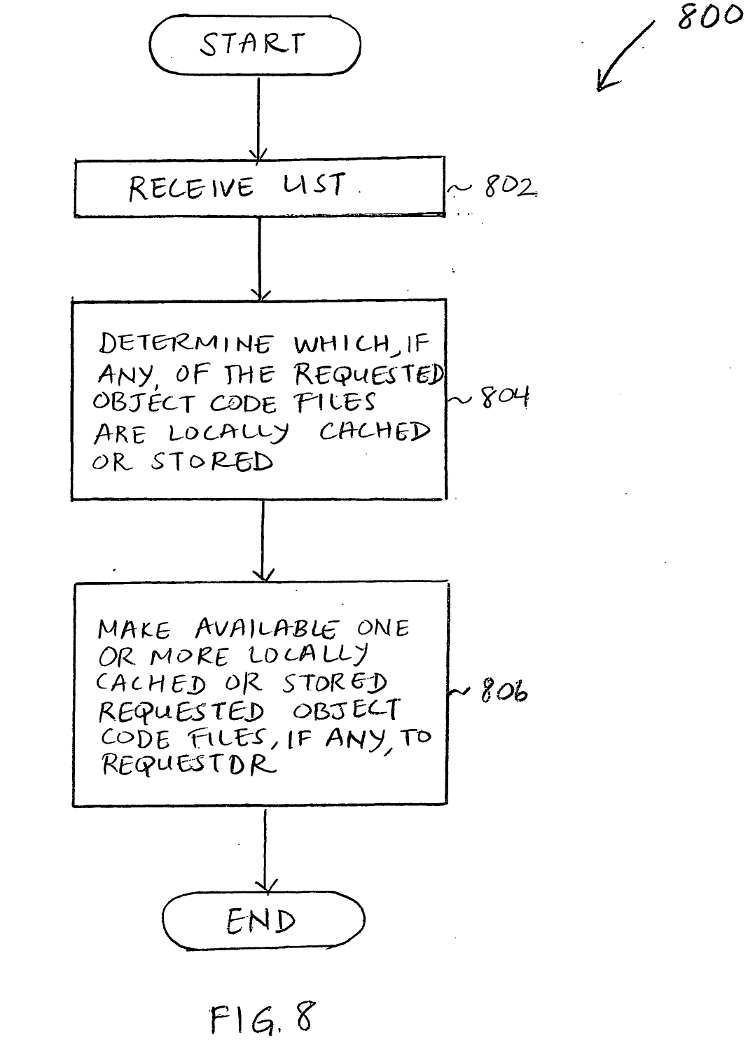

FIG. 8 illustrates an embodiment of a process for making available existing object code files. Process 800 begins at 802 at which a list of needed files (i.e. a list of desired object code files) is received. In some embodiments, a list is received at 802 upon the transmittal of such a list (e.g., at 606 of process 600 of FIG. 6) from a requesting machine that is building a code base. In some embodiments, a list generated using process 700 of FIG. 7 is received at 802. In some embodiments, the list is received at 802 by a peer machine listening for requests in an associated software development environment. In some embodiments, the list is received at 802 by a dedicated server or repository that is used to store and provide object code files that were previously generated at one or more machines in the associated software development environment. At 804, it is determined which, if any, of the requested object code files are locally cached or stored and can be made available to the requesting machine. In some embodiments, 804 includes determining whether any of the input condition signatures included in the list received at 802 match input condition signatures of the locally available object code files. At 806, one or more locally cached or stored requested object code files, if any, are made available to the requesting machine. Process 800 subsequently ends. In some embodiments, process 800 is employed by the requesting machine for making object code files that are in its own cache or storage, for example, from a previous build process, available to a current build process running on the machine.

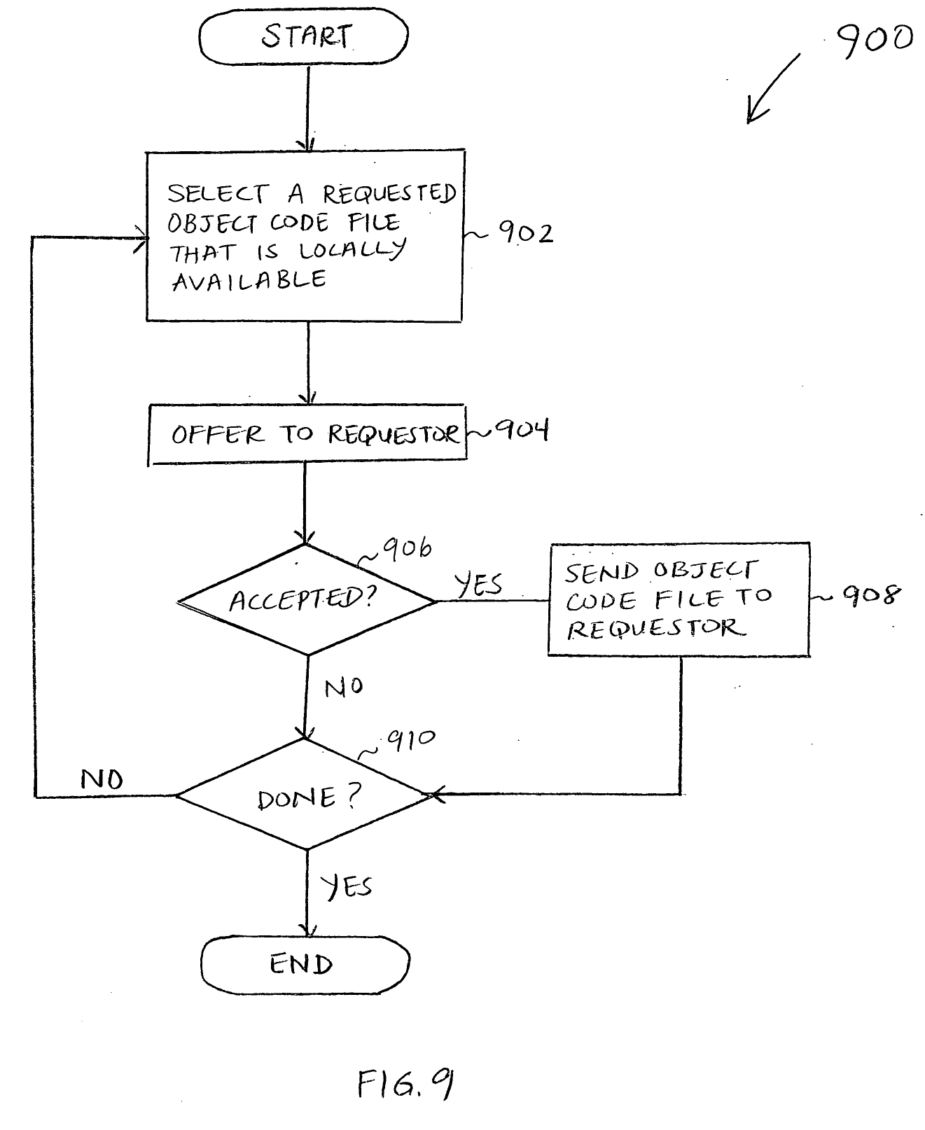

FIG. 9 illustrates an embodiment of a process for providing one or more existing object code files. In some embodiments, process 900 is employed at 806 of process 800 of FIG. 8. In some embodiments, process 900 is employed by a peer machine or a dedicated repository in a software development environment. Process 900 begins at 902 at which a requested object code file that is locally available is selected. In some embodiments, if a plurality of requested object code files are locally available, one object code file from the plurality of requested object code files is randomly selected at 902. In some embodiments, an appropriate random selection algorithm to select a random, locally available requested object code file when a plurality of such files exist is employed at each peer so that the likelihood of multiple peers in a software development environment offering the same requested object code file to the requester at any given time can be minimized.

At 904, the object code file selected at 902 is offered to the requesting machine. In some embodiments, the offer of the object code file at 904 is unicast to the requesting machine. In such cases, for example, the peer machine offering the object code file at 904 may open a connection with the requesting machine and send the input condition signature of the offered object code file to the requesting machine. In some embodiments, the offer of the object code file (e.g., its associated input condition signature) is broadcast or multicast to a group of participating machines including the requesting machine in an associated software development environment at 904, so that, for example, other peer machines can be made aware of the offered object code file so that multiple offers of the same object code file are not made to the requesting machine; so that other peers in the software development environment can be made aware that the offering peer has the specified object code file, which information may be employed by one or more of the other peers to directly request that particular object code file from the offering peer when needed; etc. In some embodiments, one or more URLs (Uniform Resource Locators) associated with the offered object code file and its associated compiler outputs, if any, are unicast to the requesting machine or multicast to the entire group of peers in a software development environment.

At 906, it is determined whether the object code file offered to the requesting machine at 904 is accepted by the requesting machine. In some embodiments, if the requesting machine no longer needs the offered object code file, it declines the offer for the object code file by aborting a connection set up by the offering machine between itself and the requesting machine. In some embodiments, a communication or token in response to the offer of 904 is received from the requesting machine at 906 and indicates whether the requesting machine accepts or declines the offer of 904. If it is determined at 906 that the offer of 904 is accepted by the requesting machine, the object code file is sent to the requesting machine at 908.

Upon sending a requested object code file to the requesting machine at 908 or if it is determined at 906 that the offer of 904 is declined by the requesting machine, it is determined at 910 whether all requested object code files that are locally available have been offered to the requesting machine. In some embodiments, the determination of 910 takes into account the object code files that other peers are providing to the requesting machine so that the same files are not offered by multiple peers. For example, the determination of 910 may be based upon an updated list sent by the requesting machine that excludes requests for object code files (e.g., excludes associated input condition signatures for object code files) that it already has obtained or compiled or is in the process of obtaining or compiling. If it is determined at 910 that at least one requested object code files that is locally available has not been offered to the requesting machine, process 900 returns to 902 at which another requested object code file that is locally available is selected. If it is determined at 910 that all requested object code files that are locally available have been offered to the requesting machine, process 900 ends. In some embodiments, if process 900 is being performed by a peer that becomes busy, for example, because it has started building the code base itself, it may abort process 900 even if all requested object code files that are locally available have not been offered to the requesting machine. In some embodiments, process 900 is employed by the requesting machine to retrieve existing object code files from its own local cache or storage and offer such files to a process associated with building the code base at the machine.

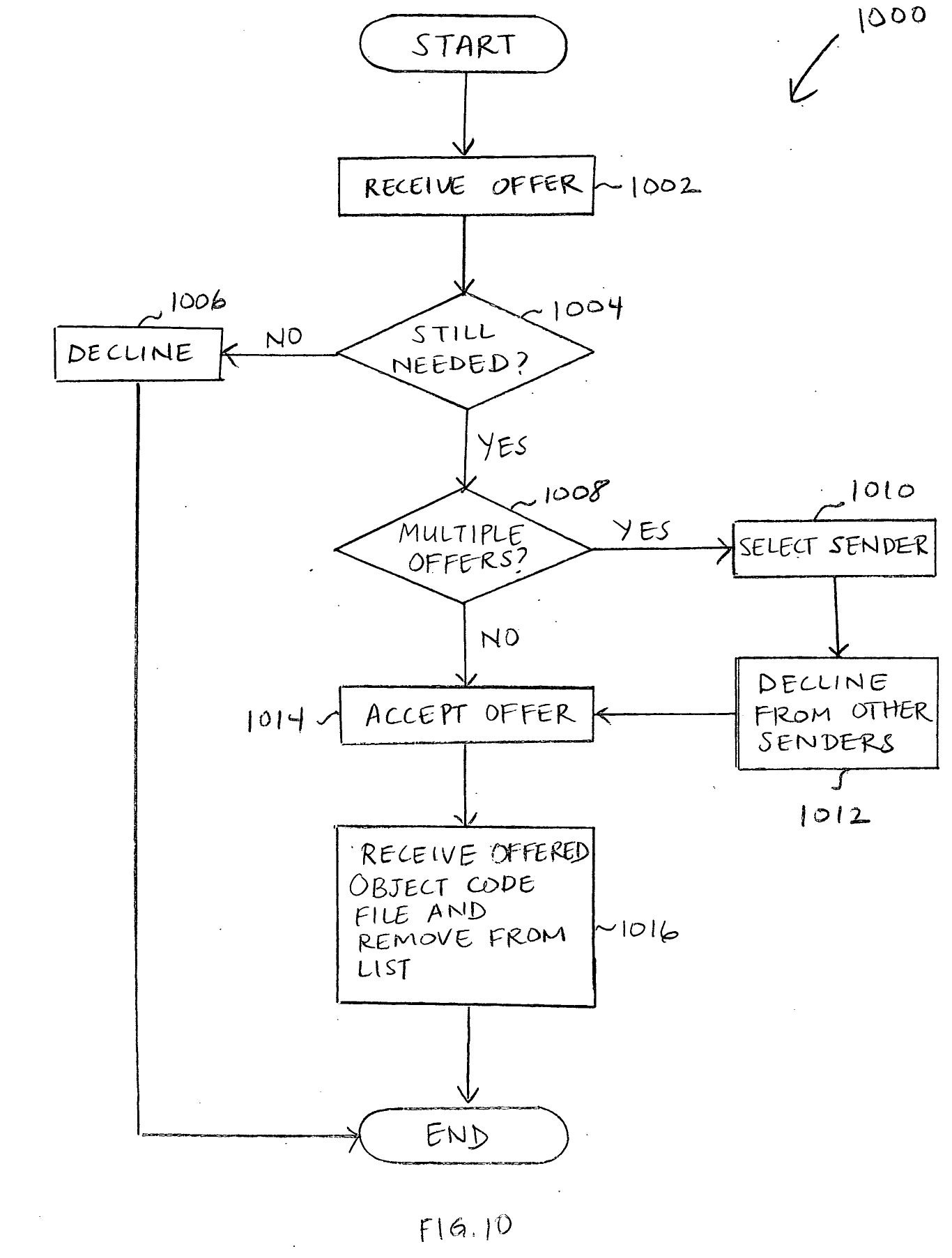

FIG. 10 illustrates an embodiment of a process for responding to an offer for an object code file. In some embodiments, process 1000 is employed by a requesting machine to respond to an offer (e.g., 904 of process 900 of FIG. 9) for a requested object code file. Process 1000 begins at 1002 at which an offer for a requested object code file is received. An offer may be received at 1002, for example, via a unicast, multicast, or broadcast from the sender. In some embodiments, the offer of 1002 comprises the input condition signature of the offered object code file and other associated compiler outputs, if any. In some embodiments, the offer of 1002 is in the form of one or more URLs to the offered object code file and other associated compiler outputs, if any. At 1004, it is determined whether the offer of 1002 is still needed. If it is determined at 1004 that the offer of 1002 is no longer needed, the offer is declined at 1006, and process 1000 subsequently ends. In some embodiments, an offer is declined at 1006 by the termination of a connection set up by the sender to communicate the offer to the requesting machine. In some embodiments, a token indicating that the offer is declined is issued to the sender at 1006.

If it is determined at 1004 that the offer of 1002 is still needed, it is determined at 1008 whether the same offer has been received from multiple potential senders. If it is determined at 1008 that the same offer has been received from multiple potential senders, a sender is selected at 1010. In some embodiments, load balancing considerations are taken into account in selecting a sender at 1010. At 1012, offers from the one or more other potential senders are declined, e.g., by terminating corresponding connections, by sending decline tokens, etc. If it is determined at 1008 that the same offer has not been received from multiple potential senders or upon selecting a sender from multiple potential senders at 1010 and declining the other potential senders at 1012, the offer is accepted from the sender or selected sender at 1014. For example, a token indicating the acceptance of the offer of 1002 may be sent to the sender or selected sender at 1014. At 1016, the offered object code file is received, and an associated entry is removed from the working list of needed files. In some embodiments, 1016 includes sending an updated list to one or more peers so that already obtained object code files are not offered to the requester. Process 1000 subsequently ends.

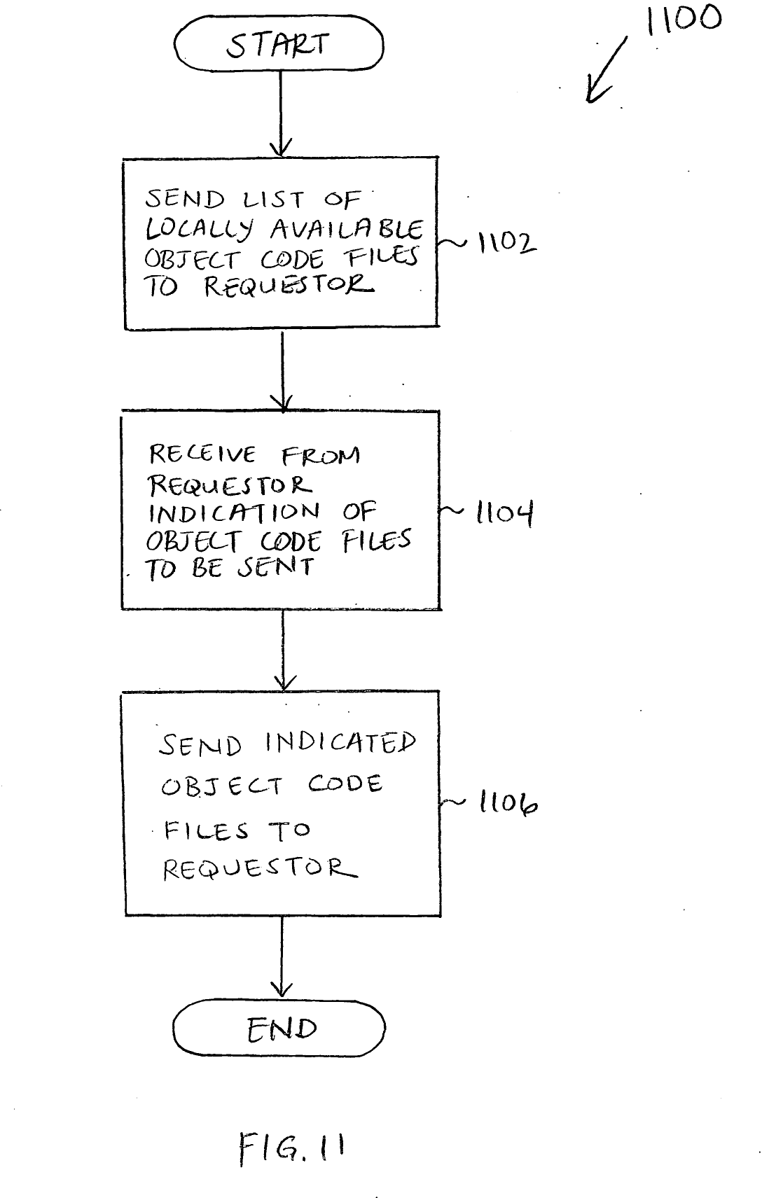

FIG. 11 illustrates an embodiment of a process for providing one or more existing object code files. In some embodiments, process 1100 is employed at 806 of process 800 of FIG. 8. In some embodiments, process 1100 is employed by a peer machine or a dedicated repository in a software development environment. Process 1100 begins at 1102 at which a list of requested object code file that are locally available is sent to the requesting machine. In some embodiments, the list of 1102 includes the input condition signatures of the requested object code files that are locally available. In some embodiments, the list is unicast to the requesting machine at 1102. In some embodiments, the list is multicast or broadcast to a group of participating machines including the requesting machine in an associated software development environment at 1102. At 1104, an indication of the object code files from the list of 1102 to be sent to the requesting machine is received from the requesting machine. Such an indication, for example, may be in the form of a list from the requesting machine that includes the identifiers (e.g., input condition signatures) of only the desired object code files from the list of object code files offered to the requesting machine at 1102. At 1106, the object code files indicated by the requesting machine at 1104 are sent to the requesting machine. Process 1100 subsequently ends.

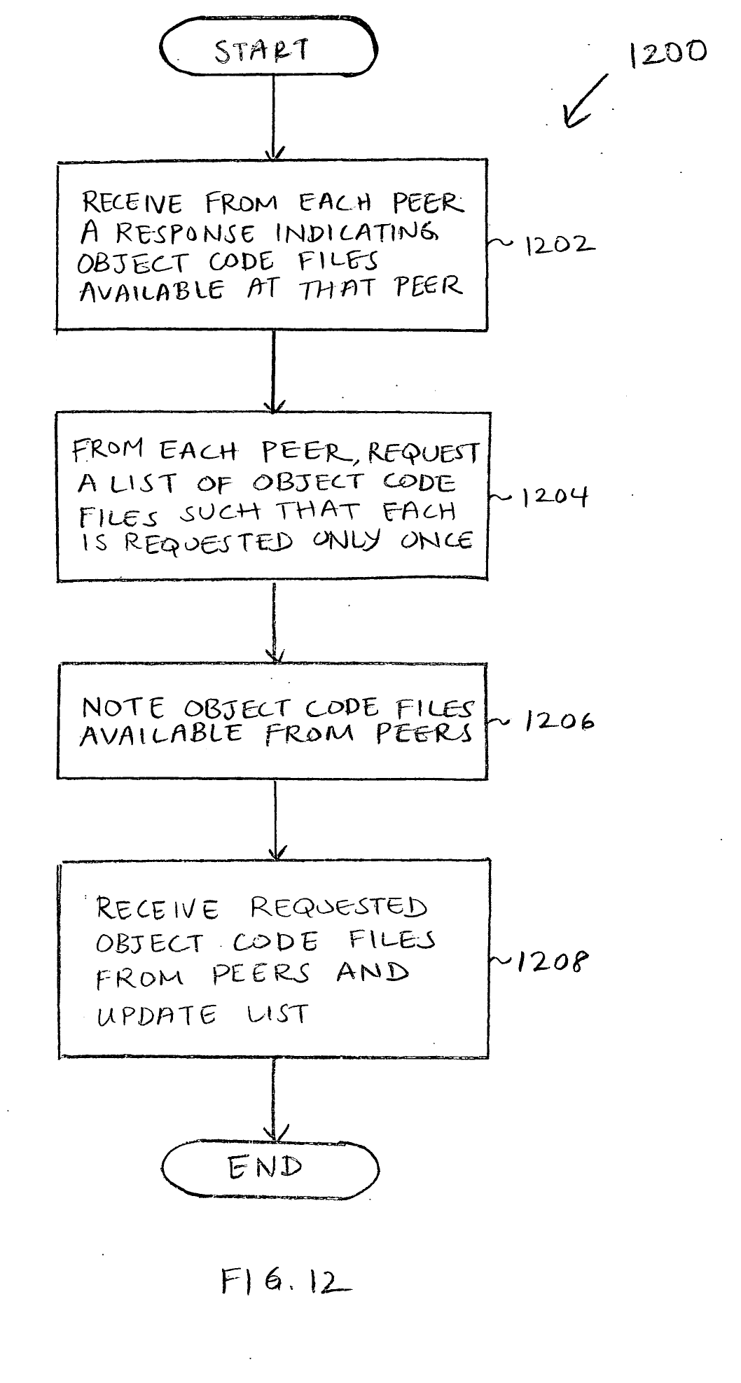

FIG. 12 illustrates an embodiment of a process for receiving object code files. In some embodiments, process 1200 is employed by a machine building a code base that has sent a list of needed object code files to one or more peer machines (such as at 606 of process 600 of FIG. 6) in an associated software development environment. In some embodiments, process 1200 is employed at 608 of process 600 of FIG. 6. Process 1200 begins at 1202 at which a response from each peer machine that is currently available to share object code files that indicates the requested object code files available at that peer is received. In some embodiments, the response received from a peer at 1202 corresponds to the list sent by the peer at 1102 of process 1100 of FIG. 11. A response from a peer may be received at 1202 via a unicast, multicast, or broadcast from the peer. At 1204, a list of one or more object code files is requested from each peer such that each object code file is requested only once. In some embodiments, the division of requests for object code files among offering peers is based at least in part on the current work load or availability of the offering peers.

At 1206, the object code files available from peers are noted. In some embodiments, the peers from which each object code file is available are noted as well as the peer from which each is requested. Thus, if an object code file is not received from the peer from which it was requested, the object code file can be requested from another peer that has the file. In some embodiments, the list of needed files such as the list generated at 604 of process 600 of FIG. 6 and/or by process 700 of FIG. 7 is appropriately marked to indicate the files that are expected to be received from peers so that, for example, the corresponding compilations are not performed at the requesting machine at least until all other needed object code files that are not available from any peers have been generated. At 1208, one or more requested object code files are received, and the working list of needed files is updated. Process 1200 subsequently ends.

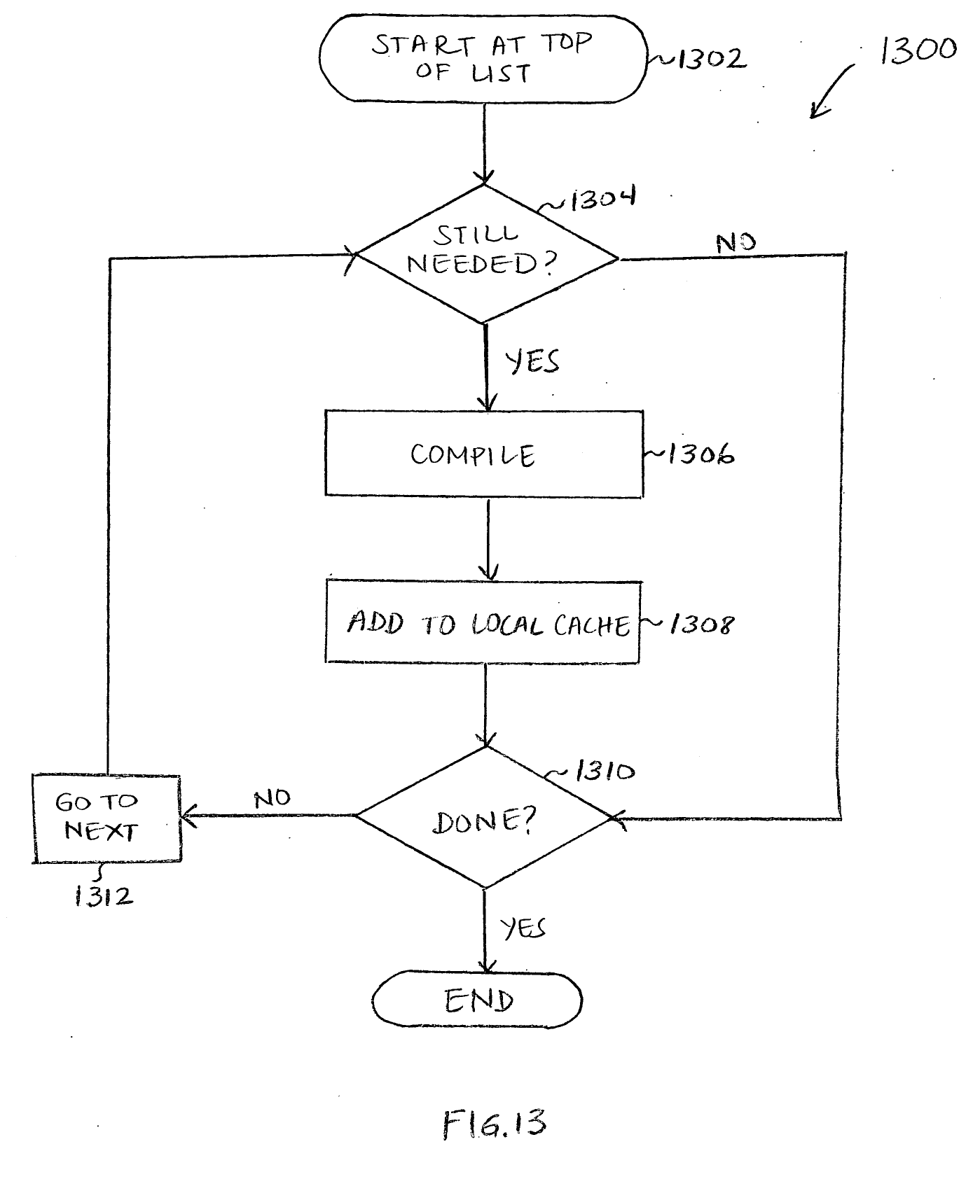

FIG. 13 illustrates an embodiment of a process for generating object code files. In some embodiments, process 1300 is employed by a machine building a code base. Process 1300 starts at 1302 with the first file in a list of needed files. In some embodiments, the list of 1302 corresponds to the list generated at 604 of process 600 of FIG. 6 and/or by process 700 of FIG. 7. In some embodiments, process 1300 starts at 1302 with the first file in the list that is not expected to be received from a peer. At 1304, it is determined if the file of 1302 is still needed. If it is determined at 1304 that the file of 1302 is still needed, the corresponding source code file is compiled at 1306 to generate the needed object code file. In some embodiments, process 1300 includes 1308 at which the generated object code file and other associated compiler outputs such as diagnostic data, an exit code, etc. are locally cached or stored in another form of memory or long term storage so that, for example, the generated compiler outputs can be reused in the future at the same machine or supplied to a peer.

Upon performing a compilation at 1306 and optionally caching the results at 1308 or if it is determined at 1304 that the file in consideration is no longer needed, for example, because it already exists in the machine's local cache or because it has been supplied by a peer, it is determined at 1310 if any other files are needed. That is, it is determined whether all the needed files in the list of needed files have been obtained. If it is determined at 1310 that a file is needed, process 1300 proceeds with the next file in the list of needed files at 1312 and returns to 1304 to determine whether the file of 1312 is still needed. If it is determined at 1310 that all files in the list of needed files have been obtained, process 1300 ends. In some embodiments, only the files in the list of files that have not been marked (such as at 1206 of process 1200 of FIG. 12) to be received by a peer are generated using process 1300. Once the files that are not expected to be received from peers have been generated, process 1300 may proceed to generate files that were expected to be received from peers but have not been received. In some embodiments, a machine building a code base may request one or more peers to perform one or more needed compilations in parallel to accelerate the build process.

In some embodiments, the sharing of object code files amongst peer machines in a software development environment is controlled at a user level. In some embodiments, the users of peer machines in the software development environment have the option of selecting whether to look for shared object code files from other peers and/or to share their own object code files. For example, a user may have the ability to select options such as “Look for shared object code” and “Share my object code” in an associated IDE. In such cases, the level of collaboration with other peers depends on the preferences of each peer. In some embodiments, peer machines participating in the sharing of resources may encrypt their communications for security purposes.

As described herein, the process of compiling source code files into object code files during a build of an associated code base can be improved if object code files generated in a software development environment are cached across one or more machines and shared so that existing object code files can be reused instead of repeatedly generating such files when building a code base. Further considering the build process, techniques similar to those described herein may be employed in the sharing of executable files. For example, if the executable files generated in a software development environment are cached and each is associated with an identifier that uniquely identifies all of the object code files that were linked to produce the executable file, executable files can be similarly reused and shared between peers in the software development environment, eliminating the processing associated with repeatedly linking the same set of object code files.

The techniques described herein are not limited to compiling or even to building a code base in a software development environment. For example, in some embodiments, similar techniques may be employed to share pre-rendered graphics files. For example, the work of a group of users may include browsing through a set of one or more image files. If an image file is complex, the amount of time needed to render the file at a machine may exceed the amount of time needed to receive a pre-rendered preview image or thumbnail from another machine in an associated network environment. The machines in a network environment may each maintain local caches of one or more preview images and may share their cached preview images with other machines using some of the techniques described herein. In such cases, the input conditions that need to be characterized to facilitate the sharing of such files may include, for example, the contents of the desired file or some suitably unique sub-range of the file, the size of the desired preview image, the desired color depth, etc.

In general, the techniques described herein may be employed to perform any process whose inputs are deterministic. In many cases, it may be more efficient to receive previously generated results or outputs of a process rather than to actually perform the process. This is possible whenever the process is repeatable, that is, the same inputs result in the same outputs.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for performing a computing task, comprising:
determining at a machine that a computing task needs to be performed;
generating a representation of a set of one or more input conditions associated with the computing task;
using the representation of the set of one or more input conditions to request from one or more other machines a previously generated set of one or more outputs of the computing task for that set of one or more input conditions; and
receiving at the machine the previously generated set of one or more outputs from one or more of the other machines.

2. A method as recited in claim 1, wherein generating a representation of a set of one or more input conditions associated with the computing task comprises generating a unique identifier for the set of one or more input conditions.

3. A method as recited in claim 1, wherein generating a representation of a set of one or more input conditions associated with the computing task comprises computing a hash of the set of one or more input conditions.

4. A method as recited in claim 1, wherein the computing task comprises compiling a source code file.

5. A method as recited in claim 1, wherein the computing task comprises rendering an image.

6. A method for obtaining a compiled version of a file, comprising:
determining at a machine that a file needs to be compiled;
requesting from one or more other machines a previously compiled version of the file; and
receiving at the machine the previously compiled version of the file from one or more of the other machines.

7. A method as recited in claim 6, wherein the file comprises a source code file.

8. A method as recited in claim 6, wherein the file is included in a set of files comprising a code base.

9. A method as recited in claim 6, wherein the file has not been modified at the machine.

10. A method as recited in claim 6, wherein requesting from one or more other machines a previously compiled version of the file includes multicasting a request for the previously compiled version of the file to the one or more other machines.

11. A method as recited in claim 6, wherein the file is part of a set of files and wherein requesting from one or more other machines a previously compiled version of the file includes multicasting to the one or more other machines a list of data associated with the set of files.

12. A method as recited in claim 6, wherein requesting from one or more other machines a previously compiled version of the file includes identifying the previously compiled version of the file by a unique identifier.

13. A method as recited in claim 12, wherein at each of the one or more other machines that has the previously compiled version of the file the previously compiled version of the file is associated with the unique identifier.

14. A method as recited in claim 12, wherein the unique identifier identifies a set of one or more compiler input conditions that affect compiling the file into a compiled version of the file.

15. A method as recited in claim 14, wherein the set of compiler input conditions that affect compiling the file into a compiled version of the file includes one or more of the following: the contents of the file, the contents of any headers or include files included either directly or recursively in the file, the version or contents of a software development kit used in compiling the file into a compiled version of the file, the version or contents of a compiler binary used in compiling the file into a compiled version of the file, any compiler flags that affect compiling the file into a compiled version of the file, any environmental variables that affect compiling the file into a compiled version of the file, and any compiler options selected in compiling the file into a compiled version of the file.

16. A method as recited in claim 12, wherein the unique identifier comprises a hash value resulting from applying a hash function to a set of one or more compiler input conditions that affect compiling the file into a compiled version of the file.

17. A method as recited in claim 6, wherein the one or more other machines comprise peer machines.

18. A method as recited in claim 6, wherein the one or more other machines comprise a dedicated server.

19. A method as recited in claim 6, wherein a compiled version of the file comprises an object code file.

20. A method as recited in claim 6, wherein a compiled version of the file includes other compiler outputs.

21. A method as recited in claim 20, wherein other compiler outputs include diagnostic data, an exit code, or both.

22. A method as recited in claim 6, wherein receiving at the machine the previously compiled version of the file from one or more of the other machines comprises receiving different portions that make up the previously compiled version of the file from one or more of the other machines.

23. A method as recited in claim 6, wherein the file is part of a set of files that need to be compiled and wherein a compiled version of each file in the set of files is generated at the machine, retrieved from storage at the machine, or received from one or more of the other machines.

24. A system for performing a computing task, comprising:
a processor configured to:
determine that a computing task needs to be performed;
generate a representation of a set of one or more input conditions associated with the computing task;
use the representation of the set of one or more input conditions to request from one or more machines a previously generated set of one or more outputs of the computing task for that set of one or more input conditions; and
receive the previously generated set of one or more outputs from one or more of the machines; and
a memory coupled to the processor and configured to provide instructions to the processor.

25. A system as recited in claim 24, wherein to generate a representation of a set of one or more input conditions associated with the computing task comprises generating a unique identifier for the set of one or more input conditions.

26. A system as recited in claim 24, wherein to generate a representation of a set of one or more input conditions associated with the computing task comprises computing a hash of the set of one or more input conditions.

27. A system for obtaining a compiled version of a file, comprising:
a processor configured to:
determine that a file needs to be compiled;
request from one or more machines a previously compiled version of the file; and
receive the previously compiled version of the file from one or more of the machines; and
a memory coupled to the processor and configured to provide instructions to the processor.

28. A system as recited in claim 27, wherein to request from one or more machines a previously compiled version of the file includes identifying the previously compiled version of the file by a unique identifier.

29. A system as recited in claim 28, wherein at each of the one or more machines that has the previously compiled version of the file the previously compiled version of the file is associated with the unique identifier.

30. A system as recited in claim 28, wherein the unique identifier identifies a set of one or more compiler input conditions that affect compiling the file into a compiled version of the file.

31. A system as recited in claim 28, wherein the unique identifier comprises a hash value resulting from applying a hash function to a set of one or more compiler input conditions that affect compiling the file into a compiled version of the file.

32. A system as recited in claim 27, wherein a compiled version of the file includes other compiler outputs.

33. A computer program product for performing a computing task, the computer program product being embodied in a computer readable medium and comprising computer instructions for:
determining at a machine that a computing task needs to be performed;
generating a representation of a set of one or more input conditions associated with the computing task;
using the representation of the set of one or more input conditions to request from one or more other machines a previously generated set of one or more outputs of the computing task for that set of one or more input conditions; and
receiving at the machine the previously generated set of one or more outputs from one or more of the other machines.

34. A computer program product for obtaining a compiled version of a file, the computer program product being embodied in a computer readable medium and comprising computer instructions for:
determining at a machine that a file needs to be compiled;
requesting from one or more other machines a previously compiled version of the file; and
receiving at the machine the previously compiled version of the file from one or more of the other machines.

35. A computer program product as recited in claim 34, wherein requesting from one or more other machines a previously compiled version of the file includes identifying the previously compiled version of the file by a unique identifier.

36. A computer program product as recited in claim 35, wherein the unique identifier comprises a hash value resulting from applying a hash function to a set of one or more compiler input conditions that affect compiling the file into a compiled version of the file.
